(19) United States
(12) Patent Application Publication
(10) Pub. No.: US 2025/0269340 A1
(43) Pub. Date: Aug. 28, 2025

(54) DISPOSABLE MIXING SYSTEM

(71) Applicant: ILC Dover LP, Frederica, DE (US)

(72) Inventors: Julien Bongard, Bulle (CH); Phillippe Grand, Corpataux (CH); Alexander Hassell, Lewes, DE (US)

(21) Appl. No.: 19/047,556

(22) Filed: Feb. 6, 2025

Related U.S. Application Data
(60) Provisional application No. 63/556,514, filed on Feb. 22, 2024.

(51) Int. Cl. B01F 35/513; B01F 23/50; B01F 25/312; B01F 35/50; B01F 35/71

(52) U.S. Cl. CPC B01F 35/513; B01F 23/56; B01F 23/59; B01F 25/312; B01F 35/514; B01F 35/7176; B01F 35/71805

(57) ABSTRACT

The present disclosure relates to a mixing system that includes an injector body comprising a first flow path configured to transmit a motive fluid, a second flow path configured to transmit a granular material, and a diffuser configured to transmit and mix the motive fluid of the first flow path with the granular material of the second flow path. A flexible vessel includes a closed end, an open end, and an interior volume configured to hold a granular material. The open end is configured to couple to the injector body at or adjacent the second flow path. A pressurized fluid inlet is configured to fluidly couple to the second flow path and configured to transmit a pressurized fluid to at least one of the interior volume of the flexible vessel and the second flow path.

### CROSS-REFERENCE TO RELATED APPLICATION

This patent application claims priority to and the benefit of, and is a non-provisional application of, U.S. Patent App. No. 63/556,514, filed Feb. 22, 2024, entitled “DISPOSABLE MIXING SYSTEM”, the entire disclosure of which is incorporated by reference herein in its entirety.

### TECHNICAL FIELD

The present disclosure relates to a mixing system. More particularly, this disclosure is directed to a mixing system with disposable components.

### BACKGROUND

Batch mixing in the biopharmaceutical, chemical, and food industries may require sterile environments and stringent cleaning processes of equipment to prevent the introduction of contaminants into a mixing process. Cleaning reusable equipment and hosing involved in the process as well as maintaining sterile working environments add to the cost of batch mixing production and equipment maintenance.

### SUMMARY

The present disclosure relates to a mixing system comprising a disposable injector and disposable vessel that cooperate to accelerate homogenous mixing of a granular material and a liquid for biopharmaceutical, chemical, and food industries.

In a first example aspect of the disclosure, a mixing system may include an injector body comprising a first flow path configured to transmit a motive fluid, a second flow path configured to transmit a granular material, and a diffuser configured to transmit and mix the motive fluid of the first flow path with the granular material of the second flow path. A flexible vessel may include a closed end, an open end, and an interior volume configured to hold a granular material. The open end may be configured to couple to the injector body at or adjacent the second flow path. A pressurized fluid inlet may be configured to fluidly couple to the second flow path and configured to transmit a pressurized fluid to at least one of the interior volume of the flexible vessel and the second flow path.

In a second example aspect of the disclosure, a mixing system may include an injector body comprising a first inlet configured for receiving a stream of motive fluid, a second inlet configured for receiving a stream of granular material, an outlet configured for delivering a mixture of fluid and granular material, and a chamber disposed between the first inlet, second inlet, and the outlet. The chamber may be configured for receiving the stream of motive fluid and the stream of granular material. A flexible vessel may be configured for sealably coupling to the second inlet of the injector body and for holding a granular material. The flexible vessel may include an interior volume and a pressurized fluid inlet in fluid communication with the interior volume. The pressurized fluid inlet may be configured for receiving a pressurized fluid.

In accordance with any one of the first and second example aspects, a mixing system may include any one or more of the following forms.

In one form, a pressure reducer may be configured to couple to the pressurized fluid inlet.

In one form, the pressure reducer may be configured to deliver a pressurized fluid.

In some forms, the pressurized fluid may be below atmospheric pressure.

In other forms, the pressurized fluid inlet may be disposed in a wall of the flexible vessel between the open end and the closed end.

In another form, the pressurized fluid inlet may be configured to transmit a pressurized fluid to the interior volume of the flexible vessel.

In yet another form, the flexible vessel may be an opaque or transparent bag.

In one example, a valve may be configured to fluidly couple the open end of the flexible vessel and the second flow path of the injector body.

In some examples, a coupling may be configured to sealably couple the open end of the flexible vessel, the valve, and the injector body.

In another example, the coupling may include a first portion configured to heat-seal to the open end of the flexible vessel and to clamp to the valve, and a second portion configured to connect the injector body to the valve.

In yet another example, the coupling may comprise a clamp.

In one aspect, the interior volume of the flexible vessel may include a first volume adjacent the closed end and a second volume adjacent the open end.

In another aspect, the pressurized fluid inlet may be disposed in a wall defining the second volume.

In some aspects, a single-use pump head may be configured to couple to the injector body.

In some examples, the injector body may comprise a polyethylene material.

Systems and methods described in the present disclosure can include one or more of the following advantages.

The mixing system constructed in accordance with the present disclosure may expedite a batch mixing process by accelerating delivery of a granular material from a flexible vessel into an injector.

In accordance with certain mixing systems of the present disclosure, the vessel holding the granular material is opaque or transparent, allowing a technician to identify any material stuck in the vessel, thereby prompting the technician to jostle or shake the vessel to free the stuck material.

In accordance with certain mixing systems of the present disclosure, the disposable vessel is light-weight and flexible, thereby facilitating assembly and disassembly of the mixing system.

In accordance with certain mixing systems of the present disclosure, many of the components of the mixing system are disposable.

In accordance with certain mixing systems of the present disclosure, overall time for assembly, mixing, and disassembly is reduced by accelerating delivery of the granular material from the flexible vessel and eliminating the need to clean any of the disposable parts.

As used herein, the terms “top,” “bottom,” “upper,” “lower,” “above,” and “below” are used to provide a relative relationship between structures. The use of these terms does not indicate or require that a particular structure must be located at a particular location in the apparatus.

Some examples may be described using the expression “coupled” and “connected” along with their derivatives. For example, some arrangements may be described using the term “coupled” to indicate that two or more elements are in direct physical or electrical contact. The term “coupled,” however, may also mean that two or more elements are not in direct contact with each other, but yet still co-operate or interact with each other. The examples described herein are not limited in this context.

Other features and advantages of the present disclosure will be apparent from the following detailed description, figures, and claims.

### BRIEF DESCRIPTION OF THE DRAWINGS

FIG. 1 is a schematic diagram of a mixing system for mixing a granular material and a liquid, the mixing system comprising a disposable injector and a disposable vessel;

FIG. 2 is a side view of an example implementation of the mixing system of FIG. 1;

FIG. 3 is a magnified view of the mixing system of FIG. 2;

FIG. 4 is a cross-sectional view of the disposable injector of the mixing system of FIG. 2;

FIG. 5 is a side view of the disposable injector of FIG. 2;

FIG. 6 is a top view of the disposable injector of FIG. 2;

FIG. 7 is a perspective view of the disposable injector of FIG. 2;

FIG. 8 is a perspective view of the disposable vessel of the mixing system of FIG. 2;

FIG. 9 is a magnified view the disposable vessel of FIG. 8; and

FIG. 10 is a schematic drawing of a control system that can be used to perform operations in accordance with the teachings of the present disclosure.

### DETAILED DESCRIPTION

The present disclosure relates to a mixing system comprising a disposable injector and disposable vessel that cooperate to accelerate homogenous mixing of a granular material and a liquid for biopharmaceutical, chemical, and food industries.

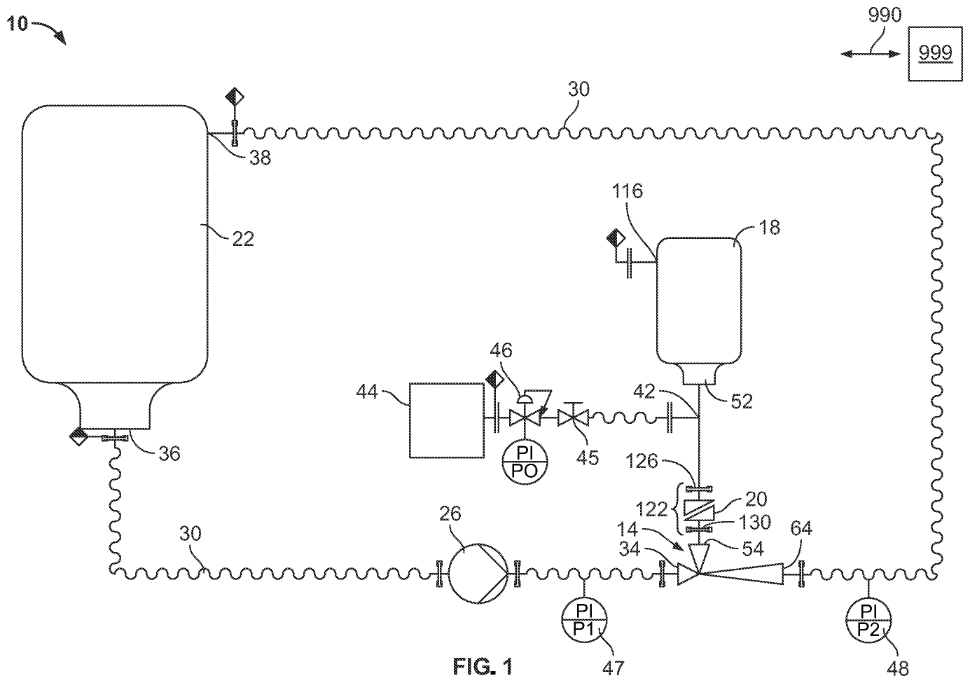

FIG. 1 is a diagram of a mixing system 10 for mixing a granular material (e.g., a powder) and a liquid. The mixing system 10 includes an injector 14, a flexible vessel 18 configured to hold a granular material, a valve 20, a reservoir 22, a pump 26, and a network of hoses or tubes 30 fluidly connecting the injector 14 and reservoir 22. The system 10 includes a low-pressure fluid inlet circuit that delivers a pressurized fluid 44 through a pressurized fluid inlet 42 into the mixing system 10 to regulate the internal pressure of the system 10 and facilitate emptying the flexible vessel 18 of its contents. The low-pressure inlet circuit includes a manual valve 45 and a low-pressure reducer 46. Optionally, the system 10 may include pressure sensors 47, 48 which may be single-use pressure sensors, positioned upstream and downstream from the injector 14, for pressure monitoring.

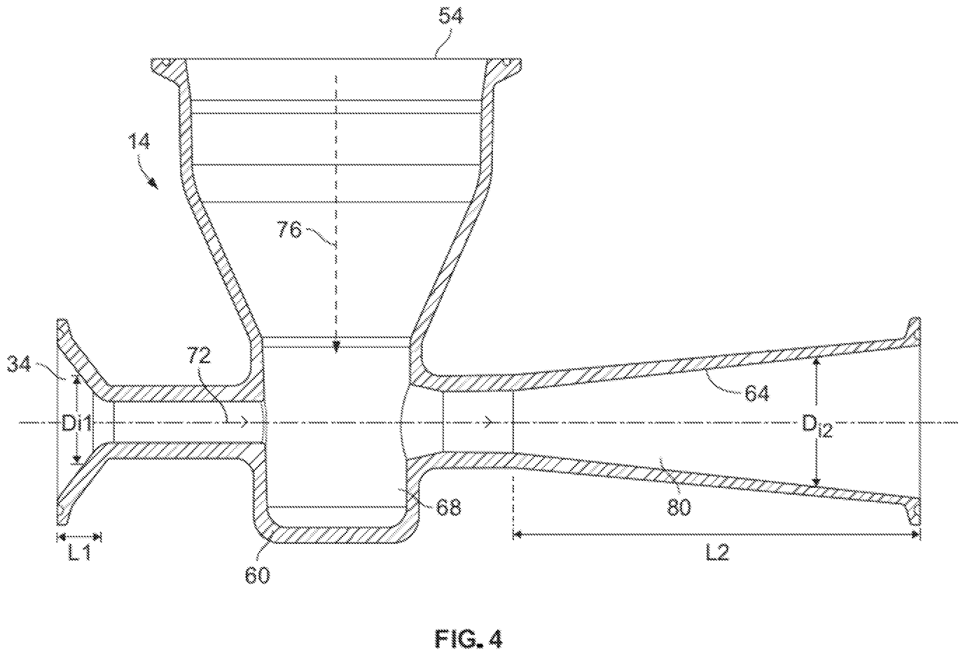

The valve 20 is a split, butterfly valve and can be controlled to open at various orientations depending on the stage of mixing. When the valve 20 is in the closed position, the flexible vessel 18 is isolated from fluid circulation, and the pump 26 can be turned on to circulate a motive fluid (e.g., initially contained in the mixing vessel 22) through the system 10. For example, the motive fluid can cycle through a mixing vessel outlet 36, through hosing 30, through a first inlet 34 of the injector 14, through an outlet 64 of the injector 14, and into a reservoir inlet 38. The flow of the liquid through the injector 14 forms a straight jet, which creates a vacuum in an injector chamber 68, which is shown in FIG. 4. During operation, the pressurized inlet 42 can be opened using the manual valve 45 and the low-pressure reducer is set to an operating pressure while the valve 20 remains closed. When the valve 20 is in an open position, granular material (initially held in the flexible vessel 18) will flow into a second inlet 54 of the injector 14, and will be sucked in and mixed with the motive fluid. The pump 26, e.g., continuously or periodically, circulates the mixture of granular material and fluid until the flexible vessel 18 is empty (e.g., completely or substantially) and the powder is properly mixed into the liquid. When the flexible vessel 18 is empty, the low-pressure air inlet 42 may be closed to disconnect the flexible vessel 18 from the valve 20. The mixing system 10, in this example, includes a control system 999 that can communicate through signals 990 (e.g., wired or wirelessly) to one or more components of the system 10. For example, control system 999 can be communicably coupled to pressure sensors 47, 48, pump 26, low-pressure reducer 46, and the valve 20. In some aspects, the control system 999 is a micro-processor based control system (or controller) that includes, e.g., hardware processor(s), memory module(s), and instructions executable as software code to cause the processor(s) to perform operations to control one or more components of the mixing system 10. However, the control system 999 can also be realized as a mechanical, electro-mechanical, hydraulic, pneumatic, or other form of a control system or controller without departing from the scope of this disclosure.

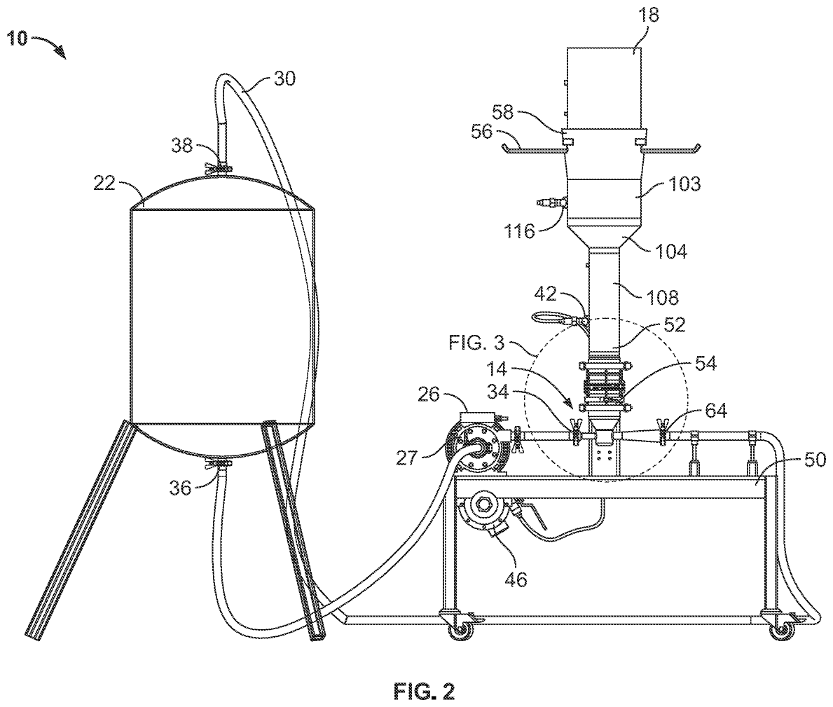

FIG. 2 is an example of a representation of the mixing system 10 of FIG. 1. The injector 14, flexible vessel 18, and pump 26 (and disposable pump head 27) are arranged on top of a table 50 adjacent to the reservoir 22, which stands on the ground. In this example, the reservoir 22 is stainless steel, and the hosing 30, flexible vessel 18, and injector 14 are disposable materials. As shown, the flexible vessel 18 is arranged in a vertical orientation relative to a horizontal surface of the table 50. An outlet 52 of the flexible bag 18 is sealably coupled to the second inlet 54 of the injector 14. More specifically, the split valve 20 is fluidly coupled to the injector 14 at the second inlet 54 and to the outlet 52 of the flexible vessel 18. A support bar 56 connected to a skirt 58 of the flexible vessel 18 holds the flexible vessel 18 in an upright configuration when attached to a stand or other support structure (mostly hidden from view), such that the granular material held in the vessel 18 is gravitationally fed into the second inlet 54 of the injector 14. In some examples, the support structure may be a portable lifting column.

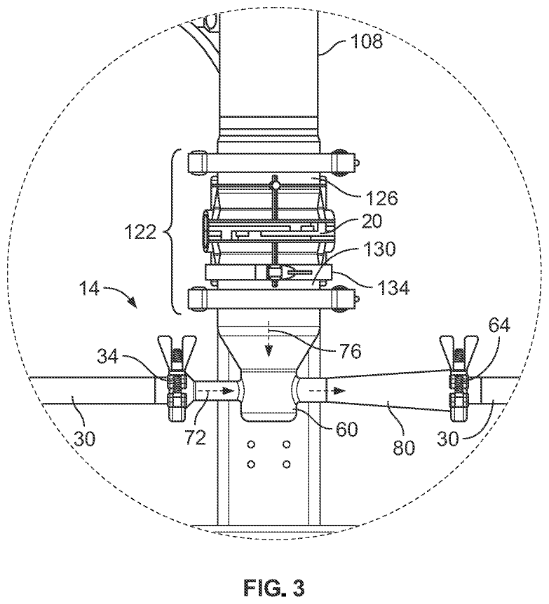

In FIGS. 3-7, the injector 14 includes an injector body 60 comprising the first inlet 34, the second inlet 54, the outlet 64 opposite the first inlet 34, and a chamber 68 disposed between the first inlet 34, the second inlet 54, and the outlet 64. As shown in FIG. 4, a first flow path 72 extends from the first inlet 34 and is configured to transmit a stream of motive fluid into the chamber 68. A second flow path 76 of the injector body 60 extends from the second inlet 54 and is configured to transmit the granular material of the vessel 18 into the chamber. The injector body 60 includes a diffuser 80 extending from the chamber 68 to the outlet 64. The injector body 60 is shaped to mix a stream of granular material received from the flexible vessel 18 with a stream of motive fluid received at the first inlet 34 to create a homogenous mixture. As shown in FIG. 4, an inner diameter Di1 of the first inlet 34 abruptly narrows (e.g., over a distance L1) toward the chamber 68 to form a convergent nozzle. The convergent nozzle shape accelerates the stream of motive fluid and creates a powerful, straight jet through the first flow path 72 and into the chamber 68. The chamber 68, defined by the walls of the injector body 60, is shaped to receive and direct the stream of granular material of the second flow path 76 towards the jet of motive fluid of the first flow path 72. Downstream from the chamber 68, the jet of motive fluid effectively sucks the granular material into the jet by the Venturi effect, and the motive fluid and granular material mix in the diffuser 80. The diffuser 80 of the injector body 60 has an inner diameter Di2 that gradually widens (e.g., over a distance L2 that is greater than L1) from the chamber 68 toward the outlet 64. The jet expands in the increased cross-sectional area of the diffuser 80 and creates an area of high turbulence to effectively mix the granular material and motive fluid.

Due to the design of the injector 14, the granular material and the motive fluid enter the injector body 60 at different pressures. The pressure differences within the injector body 60 effectively mixes the granular material and the motive fluid together. To avoid the flexible vessel 18 from collapsing from the pressure differential in the injector 14, the pressurized air inlet 42 of the system 10 is arranged to introduce a compressed air or other non-reactive gas 45, such as Nitrogen, at a low pressure into the mixing system 10 so that the pressure at the outlet 52 of the vessel 18 is at or below atmospheric pressure, such as, for example, in a range of negative 1.6 bar or more (e.g., about negative 1.55 bar or more, about negative 1.5 bar or more, about negative 1.45 bar or more, about negative 1.4 bar or more, about negative 1.35 bar or more, about negative 1.3 bar or more, about negative 1.25 bar or more, about negative 1.2 bar or more, about negative 1.15 bar or more, about negative 1.1 bar or more, about negative 1.05 bar or more, about negative 1.0 bar or more, about negative 0.95 bar) to 0 bar or less (e.g., about negative 0.05 bar or less, about negative 0.1 bar or less, about negative 0.15 bar or less, about negative 0.2 bar or less, about negative 0.25 bar or less, about negative 0.3 bar or less, about negative 0.35 bar or less, about negative 0.4 bar or less, about negative 0.45 bar or less, about negative 0.5 bar or less, about negative 0.55 bar or less, about negative 0.6 bar or less, about negative 0.65 bar or less, about negative 0.7 bar or less, about negative 0.75 bar or less, about negative 0.8 bar or less, about negative 0.85 bar or less, about negative 0.9 bar or less, about negative 0.95 bar). More specifically, when the valve 20 is in a closed position, the pressure at the second inlet 54 of the injector 14 may be in a range of negative 0.9 bar to approximately negative 0.7 bar; and when the valve 20 is in an open position, the pressure at the second inlet 54 of the injector 14 may be approximately negative 0.05 bar. Pressure sensors 47, 48 may optionally monitor the pressure of the system 10 both upstream and downstream of the injector 14. In some examples, the control system may operate the mixing system based on these pressure readings (e.g., control delivery of the pressurized fluid, close or open the valve, change a value on the low-pressure reducer 46, close the pressurized fluid inlet, etc.).

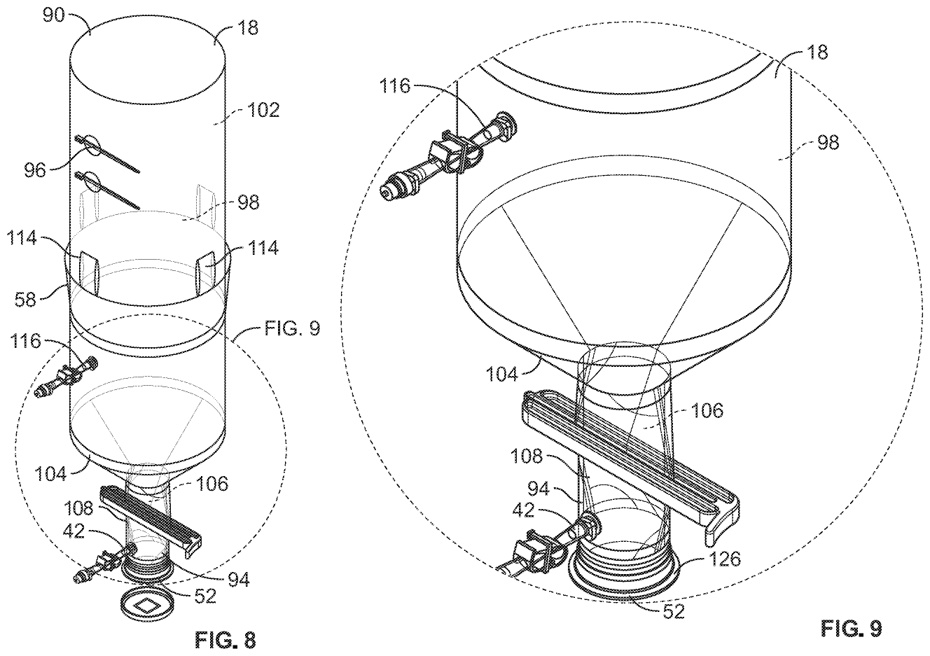

Turning now to FIGS. 8 and 9, the flexible vessel 18 has a closed end 90, an open end 94, and an interior volume 98 sized for holding a granular material or other fluid. The open end 94 defines the outlet 52 and is configured to couple to the injector body 60 at or adjacent the second flow path 76. The flexible vessel 18 has a generally cylindrical body 103 (see FIG. 1), a tapered portion 104, and cylindrical outlet portion 108. The interior volume 98 includes a first volume 102 adjacent the closed end 90 and defined by the cylindrical body 103, and a second volume 106 adjacent the open end 94 and defined by the cylindrical outlet portion 108.

The skirt 58 is disposed on an exterior surface of the cylindrical body 103 and has a plurality of loops 114 for hooking onto a support stand or other suspension structure. The flexible vessel 18 also includes a plurality of fasteners (e.g., zip-ties) 96 for coupling the vessel 18 to a support stand, closing the vessel 18 after filling with powder, and/or reducing the first volume 102 by fastening the vessel 18 in a collapsed configuration. In some examples, the flexible vessel 18 is an opaque or transparent bag such that the granular material or fluid disposed in the interior volume 98 is externally visible.

To prevent the flexible vessel 18 from collapsing onto itself due to the low pressure at the injector 14, the pressurized fluid inlet 42 is configured to supply a low pressure fluid to one or more of the interior volume 98 of the flexible vessel 18 and the second flow path 76 of the injector body 60. In the illustrated example, the pressurized fluid inlet 42 is disposed in a wall of the cylindrical outlet portion 108, which defines the second volume 106 of the flexible vessel 18, and between the open end 94 and the closed end 90. The pressurized fluid inlet 42 is positioned above the outlet 52 of the vessel 18 to optimize powder flow into the injector 14. The pressurized fluid is at or below atmospheric pressure, and is controllably delivered to the system 10 by operating a valve 45 (FIG. 1) between the low-pressure reducer 46 and the pressurized fluid inlet 42. For example, the pressurized fluid may in a range of 0 bar or more (e.g., about 1 mbar or more, about 1.5 mbar or more, about 2 mbar or more, about 2.5 mbar or more, about 3 mbar or more, about 3.5 mbar or more, about 4 mbar or more, about 4.5 mbar or more, about 5 mbar or more, about 5.5 mbar or more, about 6 mbar or more, about 6.5 mbar or more, about 7 mbar or more, about 7.5 mbar or more, about 8 mbar or more, about 8.5 mbar or more, about 9 mbar or more, about 9.5 mbar or more, about 10 mbar or more, about 10.5 mbar or more, about 11 mbar or more, about 11.5 mbar or more, about 12 mbar or more, about 12.5 mbar or more, about 13 mbar or more, about 13.5 mbar or more, about 14 mbar or more, about 14.5 mbar or more, about 15 mbar or more, about 15.5 mbar or more, about 16 mbar or more, about 16.5 mbar or more, about 17 mbar or more, about 17.5 mbar or more, about 18 mbar or more, about 18.5 mbar or more, about 19 mbar or more, about 19.5 mbar or more, about 20 mbar or more, about 20.5 mbar or more, about 21 mbar or more, about 21.5 mbar or more, about 22 mbar or more, about 22.5 mbar) to 45 mbar or less (e.g., about 44.5 mbar or less, about 44 mbar or less, about 43.5 mbar or less, about 43 mbar or less, about 42.5 mbar or less, about 42 mbar or less, about 41.5 mbar or less, about 41 mbar or less, about 40.5 mbar or less, about 40 mbar or less, about 39.5 mbar or less, about 39 mbar or less, about 38.5 mbar or less, about 38 mbar or less, about 37.5 mbar or less, about 37 mbar or less, about 36.5 mbar or less, about 36 mbar or less, about 35.5 mbar or less, about 35 mbar or less, about 34.5 mbar or less, about 34 mbar or less, about 33.5 mbar or less, about 33 mbar or less, about 32.5 mbar or less, about 32 mbar or less, about 31.5 mbar or less, about 31 mbar or less, about 30.5 mbar or less, about 30 mbar or less, about 29.5 mbar or less, about 29 mbar or less, about 28.5 mbar or less, about 28 mbar or less, about 27.5 mbar or less, about 27 mbar or less, about 26.5 mbar or less, about 26 mbar or less, about 25.5 mbar or less, about 25 mbar or less, about 24.5 mbar or less, about 24 mbar or less, about 23.5 mbar or less, about 23 mbar or less, about 22.5 mbar).

The flexible vessel 18 includes a second inlet 116 used for washing the vessel 18 before detaching the vessel 18 from the injector 14. The pressurized fluid inlet 42 and the second inlet 116 of the flexible vessel 18 are coupled to quick connect and disconnect fittings.

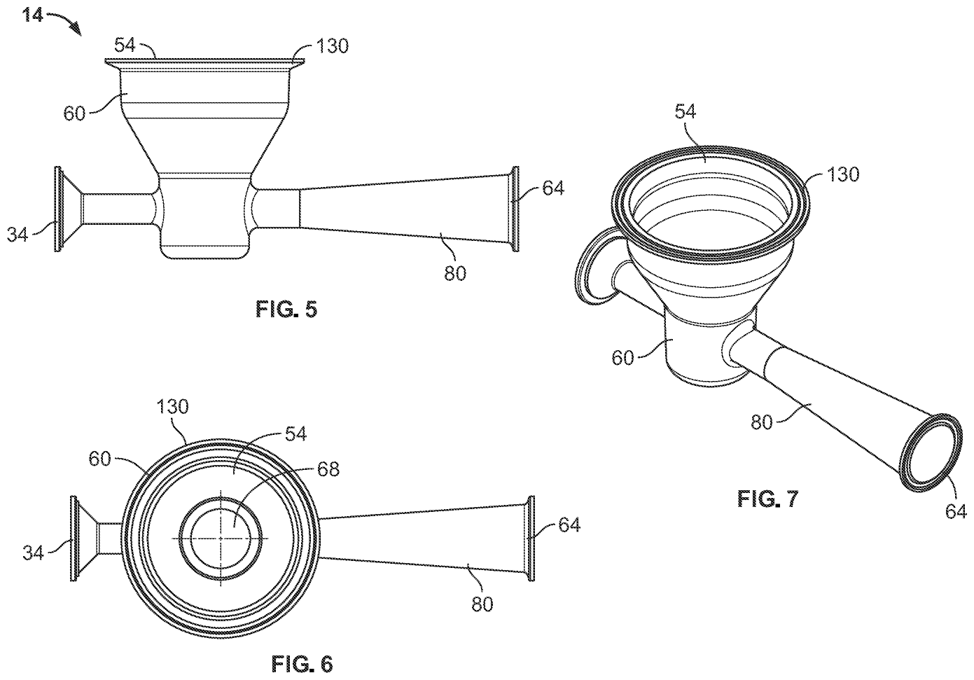

Returning briefly to FIG. 1, the valve 20 fluidly couples the outlet 52 of the flexible vessel 18 and the second flow path 76 of the injector body 60. A coupling 122 sealably couples the outlet 52 of the flexible vessel 18, the valve 20, and the second inlet 54 of the injector 14. The coupling 122 has a first portion 126 and a second portion 130. As shown in FIGS. 8 and 9, the first portion 126 is heat-sealed to the open end 94 of the flexible vessel 18 and clamps to the valve 20. As shown in FIGS. 5-7, the second portion 130 is integrated with the injector body 60 and is arranged to couple the injector 14 to the valve 20. In some examples, the coupling 122 comprises a clamp 134, as shown in FIG. 3, that clamps the first and second portions 126, 130 to the valve 20.

The injector 14, hosing 30, pump head 27, and flexible vessel 18 are disposable components of the mixing system 10. The injector body 60 is made of a durable plastic, such as polyethylene (e.g., Marlex® 9018 polyethylene), that may be formed by injection molding, thermoforming, or compression molding, but may instead be formed of any other suitable and durable material including metal, fiberglass, or other similar materials, or any combination of these materials. The flexible vessel 18 is made of a flexible plastic film, such as ArmorFlex®114, but may instead be of any other suitable and durable material including PVC and polyethylene. The pump head is made of polypropylene or other suitable and durable material. The hosing 30 is a braid-reinforced silicone tubing or other suitable and durable material.

With reference to FIGS. 1-9, an example operation of the mixing system 10 can be performed to homogenously mix a granular material with a liquid. One or more steps of the example operation can be performed by or with the control system 999 (e.g., with input from a human operator). For instance, the operation can include monitoring an internal pressure of the system 10 (e.g., communicating with pressure sensors 47, 48), and operating the valve 45 to control the amount of pressurized fluid is delivered through the pressurized inlet 42. The operation can include monitoring a weight of the flexible vessel 18 such that when the weight reaches a threshold value indicating that the flexible vessel 18 is empty, the valve 20 can close and the pump can turn off after a desired time of circulating the mixture. The operation can include operating the pump continuously or periodically based on a desired mixing rate and mode.

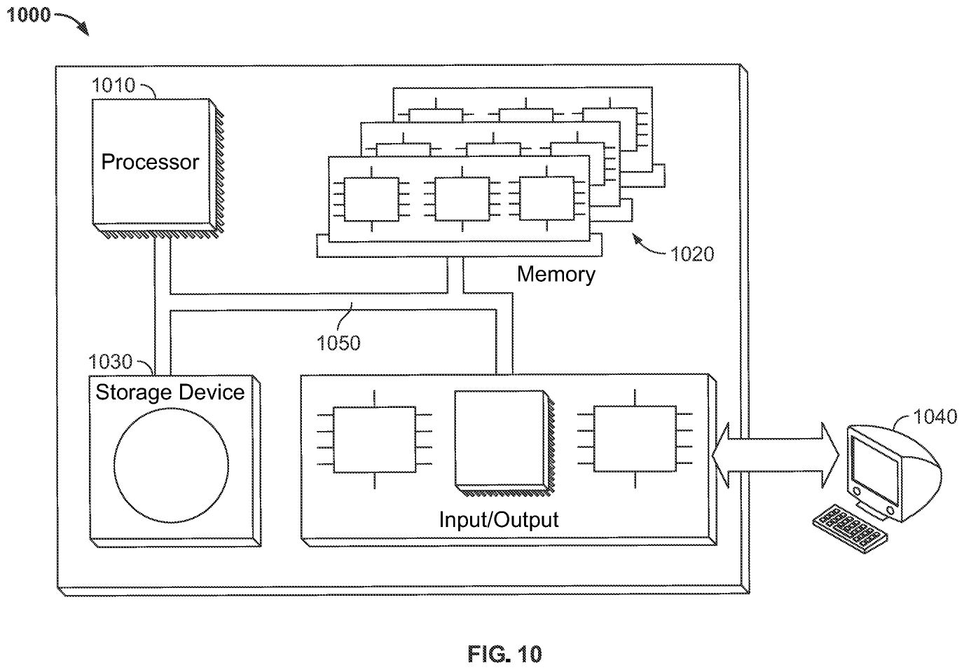

FIG. 10 shows a schematic drawing of a control system 1000 that can be used, e.g., as control system 999, to perform operations according to the present disclosure. Some or all of the example control system 1000 can be implemented as cloud-based system and/or service, alone or in combination with other portions of the example control system 1000 that can be implemented to execute. The control system 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The control system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the control system 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the control system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the control system 1000 In one implementation, the storage device 1030 is a computer-readable medium. In various different implementations, the storage device 1030 may be a floppy disk device, a hard disk device, an optical disk device, a tape device, flash memory, a solid state device (SSD), or a combination thereof.

The input/output device 1040 provides input/output operations for the control system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A mixing system, comprising:
an injector body comprising a first flow path configured to transmit a motive fluid, a second flow path configured to transmit a granular material, and a diffuser configured to transmit and mix the motive fluid of the first flow path with the granular material of the second flow path;
a flexible vessel comprising a closed end, an open end, and an interior volume configured to hold a granular material, the open end configured to couple to the injector body at or adjacent the second flow path; and
a pressurized fluid inlet configured to fluidly couple to the second flow path and configured to transmit a pressurized fluid to at least one of the interior volume of the flexible vessel and the second flow path.

2. The mixing system of claim 1, comprising a pressure reducer configured to couple to the pressurized fluid inlet, the pressure reducer configured to deliver a pressurized fluid.

3. The mixing system of claim 1, wherein the pressurized fluid is at or below atmospheric pressure.

4. The mixing system of claim 1, wherein the pressurized fluid inlet is disposed in a wall of the flexible vessel between the open end and the closed end.

5. The mixing system of claim 1, wherein the pressurized fluid inlet is configured to transmit a pressurized fluid to the interior volume of the flexible vessel.

6. The mixing system of claim 1, wherein the flexible vessel is an opaque or transparent bag.

7. The mixing system of claim 1, further comprising:
a valve configured to fluidly couple the open end of the flexible vessel and the second flow path of the injector body.

8. The mixing system of claim 7, comprising a coupling configured to sealably couple the open end of the flexible vessel, the valve, and the injector body, wherein the coupling comprises a first portion configured to heat-seal to the open end of the flexible vessel and to clamp to the valve, a second portion configured to connect the injector body to the valve, and a clamp.

9. The mixing system of claim 1, wherein the interior volume of the flexible vessel includes a first volume adjacent the closed end and a second volume adjacent the open end; and
wherein the pressurized fluid inlet is disposed in a wall defining the second volume.

10. The mixing system of claim 1, further comprising:
a single-use pump head configured to couple to the injector body.

11. The mixing system of claim 1, wherein the injector body comprises a polyethylene material.

12. A mixing system comprising:
an injector body comprising a first inlet configured for receiving a stream of motive fluid, a second inlet configured for receiving a stream of granular material, an outlet configured for delivering a mixture of fluid and granular material, and a chamber disposed between the first inlet, second inlet, and the outlet, the chamber configured for receiving the stream of motive fluid and the stream of granular material; and
a flexible vessel configured for sealably coupling to the second inlet of the injector body and for holding a granular material, the flexible vessel comprising an interior volume and a pressurized fluid inlet in fluid communication with the interior volume, the pressurized fluid inlet configured for receiving a pressurized fluid.

13. The mixing system of claim 12, further comprising:
a pressure reducer configured for coupling to the pressurized fluid inlet of the flexible vessel, the pressure reducer configured for delivering the pressurized fluid to the interior volume of the flexible vessel.

14. The mixing system of claim 12, wherein the pressurized fluid is at or below atmospheric pressure.

15. The mixing system of claim 12, wherein the flexible vessel is an opaque or transparent bag.

16. The mixing system of claim 12, further comprising:
a valve configured for fluidly coupling an open end of the flexible vessel and the second inlet of the injector body.

17. The mixing system of claim 16, further comprising:
a coupling configured for sealably coupling the open end of the flexible vessel, the valve, and the injector body, wherein the coupling comprises a first portion configured for heat-sealing to the open end of the flexible vessel and clamp to the valve, a second portion configured for connecting the injector body to the valve, and a clamp.

18. The mixing system of claim 12, wherein the flexible vessel comprises a first volume adjacent a closed end and a second volume adjacent an open end; and
wherein the pressurized fluid inlet is disposed in a wall defining the second volume.

19. The mixing system of claim 12, further comprising:
a single-use pump head configured for coupling to the injector body.

20. The mixing system of claim 12, wherein the injector body comprises a polyethylene material.
